(19) United States
(12) Patent Application Publication
(10) Pub. No.: US 2020/0183532 A1
(43) Pub. Date: Jun. 11, 2020

(54) TOUCH DISPLAY APPARATUS AND CONTROLLING METHOD THEREOF

(71) Applicant: Au Optronics Corporation, Hsinchu (TW)

(72) Inventor: Tsung-Hsuan Ho, Hsinchu (TW)

(73) Assignee: Au Optronics Corporation, Hsinchu (TW)

(21) Appl. No.: 16/667,924

(22) Filed: Oct. 30, 2019

Related U.S. Application Data
(60) Provisional application No. 62/775,469, filed on Dec. 5, 2018.

(30) Foreign Application Priority Data
Apr. 17, 2019 (TW) 108113477

(51) Int. Cl. G06F 3/041; G06F 3/044

(52) U.S. Cl. CPC G06F 3/0418; G02F 1/13338; G06F 3/044; G06F 3/0412

(57) ABSTRACT

A touch display apparatus and a controlling method thereof are provided. The touch display apparatus includes a touch display panel, a plurality of display pixels, a plurality of common electrodes, a plurality of common voltage transmission switches, and a plurality of data transmission switch sets. The display pixels are divided into a plurality of display areas. The common electrodes respectively correspond to the display areas. The common voltage transmission switches respectively determine whether to transport a plurality of common voltages to the common electrodes according to a plurality of control signals. The data transmission switch sets respectively correspond to the common voltage transmission switches and are respectively controlled by a plurality of multiplexer signals, and turn-on or turn-off states of each of the data transmission switch sets and the corresponding common voltage transmission switch are identical.

### CROSS-REFERENCE TO RELATED APPLICATION

This application claims the priority benefits of U.S. provisional application Ser. No. 62/775,469, filed on Dec. 5, 2018, and Taiwan application serial no. 108113477, filed on Apr. 17, 2019. The entirety of each of the above-mentioned patent applications is hereby incorporated by reference herein and made a part of this specification.

### BACKGROUND

### Technical Field

The invention relates to a touch display apparatus and a controlling method thereof, and particularly relates to a touch display apparatus capable of reducing noise and a controlling method thereof.

### Description of Related Art

In a conventional technique, a stylus may adopt an Active Electrostatic Solution (AES) method to enhance accuracy of a screen edge and reduce parallax. However, the stylus of the conventional technique must have a power supply for usage. In another conventional technique, in order not to set a power switch on the stylus, and to save power consumption, a signal transmitter is set on a touch display apparatus to output wake-up signals at intervals. When the stylus is close to the touch display apparatus, the stylus may start to work according to the received wake-up signal. Moreover, when the stylus leaves a sensing range of the touch display apparatus, the signal transmitter retransmits the wake-up signal.

In the above conventional technique, since it is required to configure a plurality of signal transmitters on the touch display apparatus and send the wake-up signals in the same time interval, a certain amount of noise is generated and display quality of the touch display apparatus is affected.

### SUMMARY

The invention is directed to a touch display apparatus and a controlling method thereof, which is adapted to reduce generated noise energy to improve display quality.

The invention provides a touch display apparatus including a touch display panel. The touch display panel includes a plurality of display pixels, a plurality of common electrodes, a plurality of common voltage transmission switches, and a plurality of data transmission switch sets. The display pixels are disposed on the touch display panel and divided into a plurality of display areas. The common electrodes are disposed on the touch display panel and respectively correspond to the display areas. The common voltage transmission switches are respectively coupled to the common electrodes. The common voltage transmission switches respectively determine whether to transport a plurality of common voltages to the common electrodes according to a plurality of control signals. The data transmission switch sets respectively correspond to the common voltage transmission switches. The data transmission switch sets are respectively controlled by a plurality of multiplexer signals, and turn-on or turn-off states of each of the data transmission switch sets and the corresponding common voltage transmission switch are the same.

The invention provides a controlling method adapted to a touch display apparatus. The touch display apparatus includes a touch display panel. The touch display panel includes a plurality of display pixels, a plurality of common electrodes, a plurality of common voltage transmission switches, and a plurality of data transmission switch sets. The controlling method includes the following steps. The touch display panel of the touch display apparatus is divided into a plurality of display areas. Each of the display areas includes the display pixels, and the common electrodes are respectively disposed on the display areas. The common voltage transmission switches are respectively set to be coupled to the common electrodes. A plurality of control signals are respectively provided to the common voltage transmission switches. The control signals are used for respectively controlling the common voltage transmission switches to determine whether to respectively transport a plurality of common voltages to the common electrodes. The data transmission switch sets are respectively set to correspond to the common voltage transmission switches, and a plurality of multiplexer signals are provided to respectively control the data transmission switch sets. Turn-on or turn-off states of each of the data transmission switch sets and the corresponding common voltage transmission switch are the same.

Based on the above description, the plurality of common electrodes are respectively configured corresponding to the plurality of display areas of the touch display panel, and the common voltage transmission switches are used to synchronize the operation of receiving the common voltage by each of the common electrodes with a charging operation of the display pixel corresponding to each of the common electrodes. In this way, when the display pixel does not execute the charging operation, voltages on both ends of a pixel capacitor of the display pixel may have a similar voltage recovery capability, which may reduce an interference of display quality caused by noise.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch display apparatus according to an embodiment of the invention.

FIG. 2 is a schematic diagram of a partial structure of a touch display apparatus according to another embodiment of the invention.

FIG. 3 is a partial circuit schematic diagram of a touch display apparatus according to an embodiment of the invention.

FIG. 4 is a waveform diagram of a touch display apparatus according to an embodiment of the invention.

FIG. 5 is a schematic diagram of voltages at two ends of a display pixel of the touch display apparatus according to an embodiment of the invention.

FIG. 6 is a schematic diagram of a configuration of common electrodes of a touch display apparatus according to an embodiment of the invention.

FIG. 7 is a schematic diagram of another configuration of common electrodes of a touch display apparatus according to an embodiment of the invention.

FIG. 8A to FIG. 8C are structural diagrams of different implementations of a touch display panel of the touch display apparatus according to an embodiment of the invention.

FIG. 9 is a flowchart illustrating a controlling method of a touch display apparatus according to an embodiment of the invention.

### DESCRIPTION OF THE EMBODIMENTS

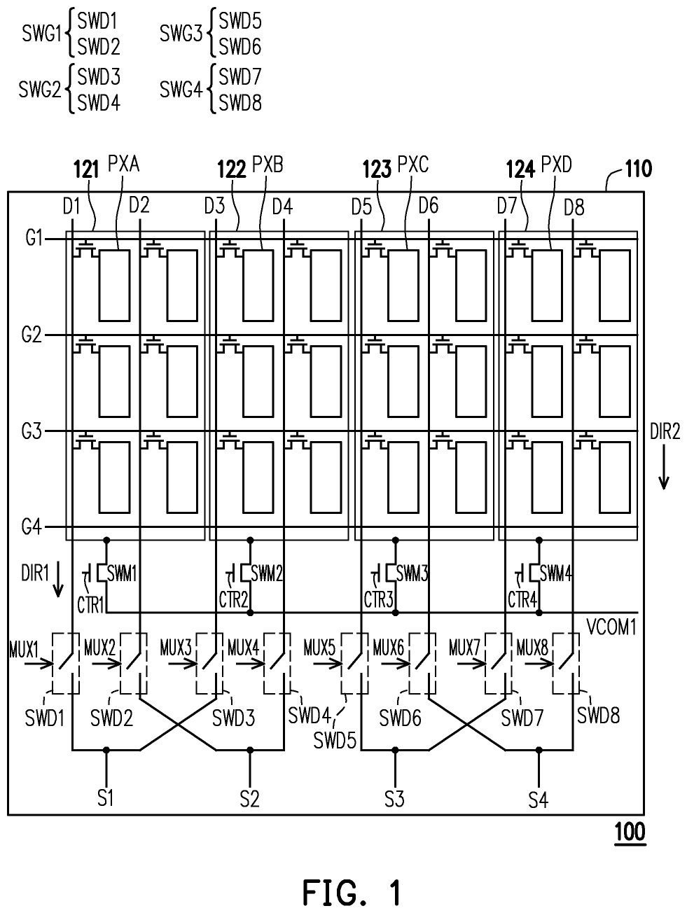

Referring to FIG. 1, FIG. 1 is a schematic diagram of a touch display apparatus according to an embodiment of the invention. The touch display apparatus 100 includes a touch display panel 110. The touch display panel 110 includes display pixels PXA-PXD, common electrodes 121-124, common voltage transmission switches SWM1-SWM4 and data transmission switches SWD1-SWD8. The display pixels PXA-PXD are disposed on the touch display panel 110, and divided into a plurality of display areas. In the embodiment, the display pixels PXA-PXD are divided into four display areas, and respectively correspond to the common electrodes 121-124, and in the embodiment, ranges of the common electrodes 121-124 respectively correspond to ranges of the four display areas. A plurality of gate lines G1-G4 and a plurality of data transmission lines D1-D8 are configured on the touch display panel 110. Each of the display pixels PXA-PXD is coupled to one of the gate lines G1-G4 and one of the data transmission lines D1-D8. The common voltage transmission switches SWM1-SWM4 are respectively coupled to the common electrodes 121-124, and the common voltage transmission switches SWM1-SWM4 commonly receive a common voltage VCOM1. Moreover, control terminals of the common voltage transmission switches SWM1-SWM4 respectively receive control signals CTR1-CTR4, where the control signals CTR1-CTR4 are respectively used for controlling a turn-on/off state of the common voltage transmission switches SWM1-SWM4. Moreover, taking the common voltage transmission switch SWM1 as an example, when the common voltage transmission switch SWM1 is turned on according to the control signal CTR1, the common voltage transmission switch SWM1 may transmit the common voltage VCOM1 to the common electrode 121. Comparatively, when the common voltage transmission switch SWM1 is turned off according to the control signal CTR1, the common voltage VCOM1 is not transmitted to the common electrode 121, and the common electrode 121 presents a floating state.

On the other hand, in the embodiment, the data transmission switches SWD1-SWD8 may be divided into a plurality of data transmission switch sets. The data transmission switches SWD1, SWD2 construct a first data transmission switch set SWG1, and are coupled to the display pixel PXA corresponding to the common electrode 121; the data transmission switches SWD3, SWD4 construct a second data transmission switch set SWG2, and are coupled to the display pixel PXB corresponding to the common electrode 122; the data transmission switches SWD5, SWD6 construct a third data transmission switch set SWG3, and are coupled to the display pixel PXC corresponding to the common electrode 123; and the data transmission switches SWD7, SWD8 construct a fourth data transmission switch set SWG4, and are coupled to the display pixel PXD corresponding to the common electrode 124. Moreover, in the embodiment, the first data transmission switch set to the fourth data transmission switch set respectively correspond to the common voltage transmission switches SWM1-SWM4. Turning on/off operations of the first data transmission switch set to the fourth data transmission switch set are the same with turning on/off operations of the common voltage transmission switches SWM1-SWM4.

In detail, the data transmission switches SWD1-SWD8 are respectively controlled by multiplexer signals MUX1-MUX8, and are respectively turned on or turned off according to the multiplexer signals MUX1-MUX8. In the embodiment, the data transmission switches SWD1 and SWD3 receive a same data signal S1; the data transmission switches SWD2 and SWD4 receive a same data signal S2; the data transmission switches SWD5 and SWD7 receive a same data signal S3; and the data transmission switches SWD6 and SWD8 receive a same data signal S4.

In an operation detail, the data transmission switches SWD1 and SWD2 may be simultaneously turned on within a same first time interval according to the multiplexer signals MUX1 and MUX2, and the common voltage transmission switch SWM1 is also turned on within the first time interval. Comparatively, the data transmission switches SWD1 and SWD2 may be simultaneously turned off within a same second time interval according to the multiplexer signals MUX1 and MUX2, and the common voltage transmission switch SWM1 is also turned off within the second time interval.

Based on the above description, the data transmission switches SWD3 and SWD4 may be simultaneously turned on within the same second time interval according to the multiplexer signals MUX3 and MUX4, and the common voltage transmission switch SWM2 is also turned on within the second time interval. Comparatively, the data transmission switches SWD3 and SWD4 may be simultaneously turned off within the same first time interval according to the multiplexer signals MUX3 and MUX4, and the common voltage transmission switch SWM2 is also turned off within the first time interval.

Namely, in the embodiment, the multiplexer signals MUX1 and MUX2 respectively received by the data transmission switches SWD1, SWD2 and the control signal CTR1 received by the common voltage transmission switch SWM1 may be the same signal. The multiplexer signals MUX3 and MUX4 respectively received by the data transmission switches SWD3, SWD4 and the control signal CTR2 received by the common voltage transmission switch SWM2 may also be the same signal.

Moreover, operations of the data transmission switches SWD5, SWD6, and the common voltage transmission switch SWM3 may be synchronous with operations of the data transmission switches SWD1, SWD2, and the common voltage transmission switch SWM1, and operations of the data transmission switches SWD7, SWD8, and the common voltage transmission switch SWM4 may be synchronous with operations of the data transmission switches SWD3, SWD4 and the common voltage transmission switch SWM2, which are not repeated.

According to the above description, it is known that taking the display pixel PXA as an example, when the data transmission switches SWD1, SWD2 are turned on, and the display pixel PXA receives the data signal S1 for charging, the common voltage transmission switch SWM1 synchronously provides the common voltage VCOM1 to the common electrode 121, such that the charging operation of the display pixel PXA may be successfully completed. When the data transmission switches SWD1, SWD2 are turned off, the common voltage transmission switch SWM1 stops providing the common voltage VCOM1 to the common electrode 121, and the common electrode 121 presents a floating state. In this way, when the display pixel PXA is interfered by noise, voltage recovery ability of two ends of a pixel capacitor of the display pictogram PXA is the same after the interference. Therefore, variation of a display brightness provided by the display pixel PXA may be reduced to improve the display quality.

It should be noted that the common voltage transmission switches SWM1-SWM4 of the embodiment receive the same common voltage VCOM1. In other embodiments of the invention, the common voltage transmission switches SWM1-SWM4 may also receive a plurality of different common voltages, which is not limited by the invention. Moreover, the numbers of the common voltage transmission switches SWM1-SWM4 and the data transmission switches SWD1-SWD8 illustrated in FIG. 1 are only an example, and in the touch display apparatus of the invention, any number of the common voltage transmission switches and the data transmission switches may be set according to actual requirements, which is not limited by the invention.

It should be noted that in the embodiment, the common electrodes 121-124 extend along a first direction DIR1, and data transmission lines D1-D8 extend along a second direction DIR2. Namely, extending directions (the first direction DIR1 and the second direction DIR2) of the common electrodes 121-124 and the data transmission lines D1-D8 are the same (or parallel with each other).

Moreover, the common voltage transmission switches SWM1-SWM4 and the data transmission switches SWD1-SWD8 of the embodiment are all transistor switches. As the common voltage transmission switches SWM1-SWM4 are used for providing the DC common voltage VCOM1 to the common electrodes 121-124, or making the common electrodes 121-124 floating, the common voltage transmission switches SWM1-SWM4 do not need to use oversized transistors for configuration. Namely, the size of each of the common voltage transmission switches SWM1-SWM4 may be smaller than the size of each of the data transmission switches SWD1-SWD8.

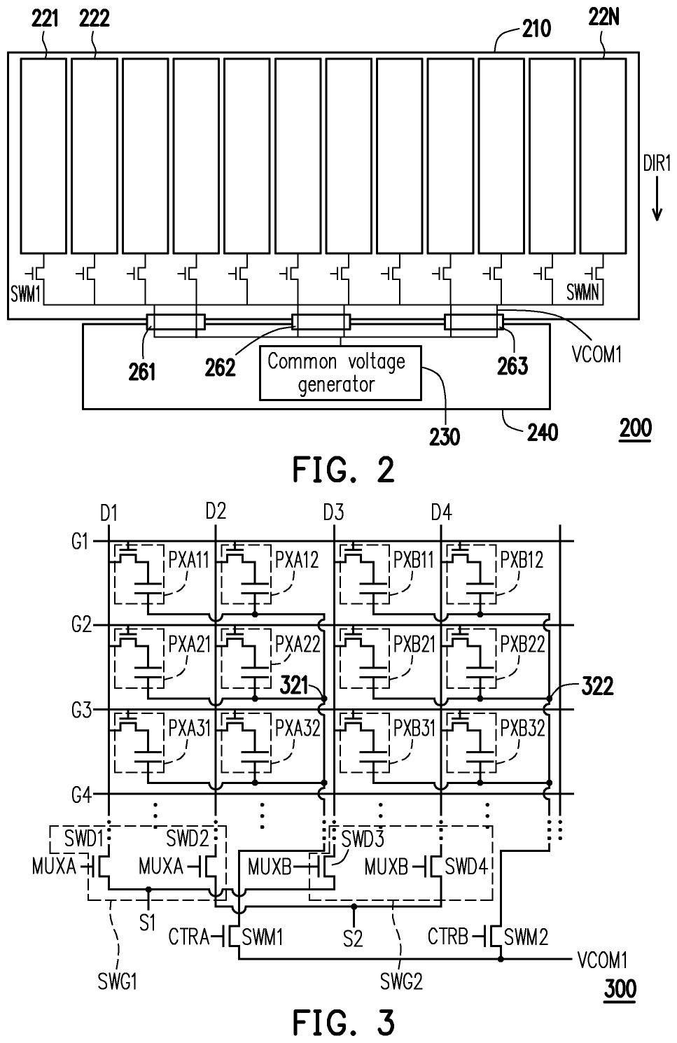

Referring to FIG. 2, FIG. 2 is a schematic diagram of a partial structure of a touch display apparatus according to another embodiment of the invention. The touch display apparatus 200 includes a touch display panel 210, a plurality of common electrodes 221-22N, a plurality of common voltage transmission switches SWM1-SWMN, and a common voltage generator 230. The common electrodes 221-22N are disposed on the touch display panel 210, and extend along the first direction DIR1. First terminals of the common voltage transmission switches SWM1-SWMN are respectively coupled to the common electrodes 221-22N, and second terminals of the common voltage transmission switches SWM1-SWMN are coupled to the common voltage generator 230 to receive the common voltage VCOM1. The common voltage generator 230 may be disposed on a circuit board 240, where the circuit board 240 and the touch display panel 210 may coupled with each other through one or a plurality of flexible circuit boards 261-263.

It should be noted that the common electrodes 221-22N are not connected with each other, and the adjacent common electrodes 221-22N have vertically configured separation spaces (extending along the first direction DIR1) there between. The common voltage transmission switches SWM1-SWMN are constructed by a plurality of transistors (for example, thin-film transistors), where the adjacent common voltage transmission switches (for example, the common voltage transmission switches SWM1 and SWM2) may receive different control signals.

Referring to FIG. 3, FIG. 3 is a partial circuit schematic diagram of a touch display apparatus according to an embodiment of the invention. In FIG. 3, the display pixels PXA11-PXA31 are coupled to the data transmission line D1, the display pixels PXA12-PXA32 are coupled to the data transmission line D2, and the data transmission switches SWD1 and SWD2 are respectively coupled to the data transmission lines D1 and D2. The display pixels PXB11-PXB31 are coupled to the data transmission line D3, the display pixels PXB12-PXB32 are coupled to the data transmission line D4, and the data transmission switches SWD3 and SWD4 are respectively coupled to the data transmission lines D3 and D4. Moreover, the display pixels PXA11-PXA31 and the display pixels PXB11-PXB31 are respectively controlled by gate lines G1-G4 according to arrangement positions.

In the embodiment, the data transmission switches SWD1 and SWD2 respectively receive the data signals S1 and S2, and are commonly controlled by a multiplexer signal MUXA. The data transmission switches SWD1 and SWD2 construct a data transmission switch set SWG1, and are configured to drive the display pixels PXA11-PXA32. The display pixels PXA11-PXA32 are coupled to the common electrode 321, and the common electrode 321 is coupled to one terminal of the common voltage transmission switch SWM1. Another terminal of the common voltage transmission switch SWM1 receives the common voltage VCOM1, and the common voltage transmission switch SWM1 is controlled by a control signal CTRA. The data transmission switches SWD3 and SWD4 respectively receive the data signals S1, S2, and are commonly controlled by a multiplexer signal MUXB. The data transmission switches SWD3 and SWD4 construct another data transmission switch set SWG2, and are configured to drive the display pixels PXB11-PXB32. The display pixels PXB11-PXB32 are coupled to the common electrode 322, and the common electrode 322 is coupled to one terminal of the common voltage transmission switch SWM2. Another terminal of the common voltage transmission switch SWM2 receives the common voltage VCOM1, and the common voltage transmission switch SWM2 is controlled by a control signal CTRB.

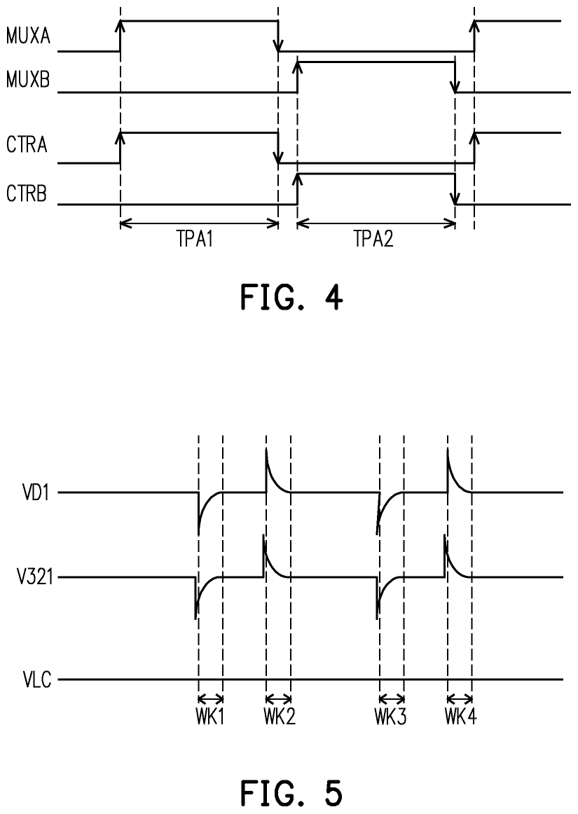

Referring to FIG. 3 and FIG. 4, where FIG. 4 is a waveform diagram of the touch display apparatus according to an embodiment of the invention. At a time interval TPA1, the multiplexer signal MUXA is pulled high to a high voltage, and the multiplexer signal MUXB is maintained to a low voltage, correspondingly, the control signal CTRA is pulled high to a high voltage, and the control signal CTRB is maintained to a low voltage. In this way, the data transmission switches SWD1 and SWD2 are turned on, and respectively transmit the data signals S1 and S2 to charge one of the display pixels PXA11-PXA31 and one of the display pixels PXA12-PXA32. Meanwhile, the common voltage transmission switch SWM1 is turned on, and transmit the common voltage VCOM1 to the common electrode 321, so that the charging operation of the display pixels may be successfully carried on.

In the time interval TPA1, the data transmission switches SWD3, SWD4 and the common voltage transmission switch SWM2 are all turned off, and the data transmission lines D3, D4 and the common electrode 322 are all in the floating state.

Moreover, at a time interval TPA2, the multiplexer signal MUXB is pulled high to the high voltage, and the multiplexer signal MUXA is pulled low to the low voltage, correspondingly, the control signal CTRB is pulled high to the high voltage, and the control signal CTRA is pulled low to the low voltage. In this way, the data transmission switches SWD3 and SWD4 are turned on, and respectively transmit the data signals S1 and S2 to charge one of the display pixels PXA11-PXA31 and one of the display pixels PXA12-PXA32. Meanwhile, the common voltage transmission switch SWM2 is turned on, and transmit the common voltage VCOM1 to the common electrode 322, so that the charging operation of the display pixels may be successfully carried on.

In the time interval TPA2, the data transmission switches SWD1, SWD2 and the common voltage transmission switch SWM1 are all turned off, and the data transmission lines D1, D2 and the common electrode 321 are all in the floating state.

Referring to FIG. 3, FIG. 4 and FIG. 5, FIG. 5 is a schematic diagram of voltages at two ends of a display pixel of the touch display apparatus according to an embodiment of the invention. Taking the display pixel PXA11 as an example, when the multiplexer signal MUXA and the control signal CTRA are simultaneously pulled low to the low voltage, the data transmission switch SWD1 and the common voltage transmission switch SWM1 are all turned off, such that the voltages (which are respectively a data voltage VD1 and a common electrode voltage V321) on the two ends (the data transmission line D1 and the common electrode 321) of the display pixel PXA11 are all in the floating state, and when the touch display apparatus 300 enters time intervals WK1-WK4 for sending wakeup signals (used for waking up the stylus), the data voltage VD1 and the common electrode voltage V321 may present a voltage jump state due to the influence of noise. Under the condition that the two ends of the display pixel PXA11 are all in the floating state, the data voltage VD1 and the common electrode voltage V321 have the same voltage recovery capability, so that a voltage variation of a voltage difference VLC between two ends of a liquid crystal capacitor of the display pixel PXA11 approaches 0. Namely, interference on the display brightness of the display pixel PXA11 due to the wakeup signal may be effectively reduced.

It should be noted after the display pixels PXA11-PXA12 on the gate line G1 complete the charging operation, the display pixels PXA11-PXA12 may be turned off according to a gate driving signal on the gate line G1. Then, the display pixels PXA21-PXA12 on the gate line G2 are turned on, and now the common electrode 321 may be again charged according to the common voltage VCOM1. It should be noted that based on the situation that the display pixels PXA11-PXA12 are in the turn-off state, regardless of a magnitude of the voltage value of the common voltage VCOM1 used for again charging, the recharging operation of the common electrode 321 does not affect electric quantities in the liquid crystal capacitors in the display pixels PX11 to PXA12, so that the display pixels PXA11-PXA12 may maintain the correct display brightness.

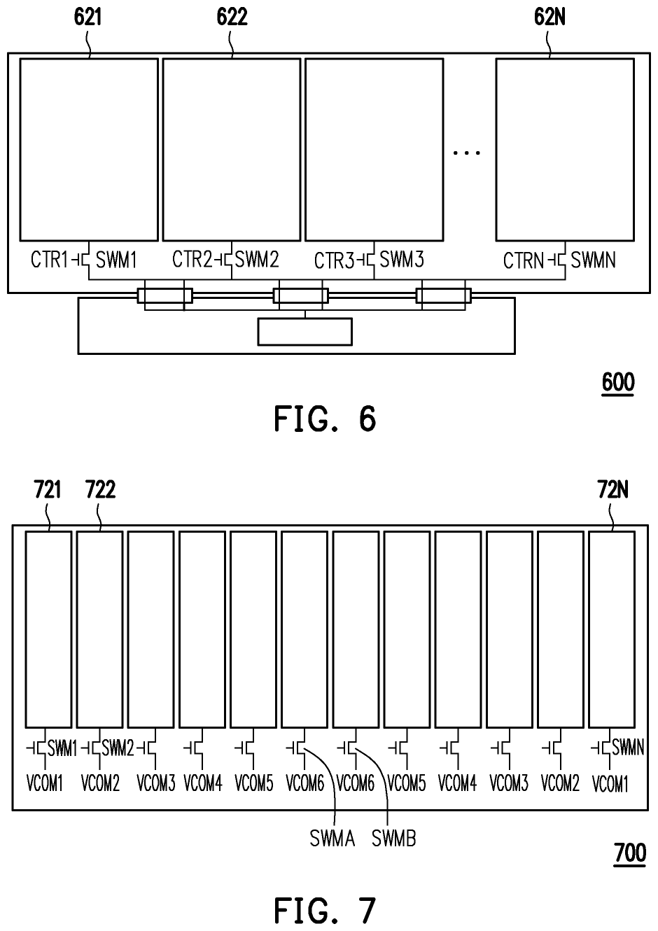

Referring to FIG. 6, FIG. 6 is a schematic diagram of a configuration of common electrodes of a touch display apparatus according to an embodiment of the invention. The touch display apparatus 600 has a plurality of common electrodes 621-62N. The common electrodes 621-62N are respectively coupled to the common voltage transmission switches SWM1-SWMN. In the embodiment, the common voltage transmission switches SWM1-SWMN are respectively controlled by a plurality of control signals CTR1-CTRN, where the control signals CTR1-CTRN may all be different. Alternatively, the control signals CTR1-CTRN may be divided into a plurality of groups, and the control signals of the same group have a same waveform, and the control signals of different groups have different waveforms. The number of the control signals of the same group may be 2, 3, 4, 6 or any integer, which is not limited by the invention.

Referring to FIG. 7, FIG. 7 is a schematic diagram of another configuration of common electrodes of a touch display apparatus according to an embodiment of the invention. The touch display apparatus 700 has a plurality of common electrodes 721-72N. The common electrodes 721-72N are respectively coupled to a plurality of common voltage transmission switches SWM1-SWMN, and the common voltage transmission switches SWM1-SWMN may receive the same or different common voltages VCOM1-VCOM6. It should be noted that in order to improve the uniformity of the common voltage received in the touch display apparatus 700, the common voltages VCOM1-VCOM6 received by the common voltage transmission switches SWM1-SWMN may be symmetrically configured according to positions of the common voltage transmission switches SWM1-SWMN. The common voltage transmission switches set at the edge (for example, the common voltage transmission switches SWM1, SWMN) may receive the same common voltage VCOM1, and the common voltage transmission switches set in the center (for example, the common voltage transmission switches SWMA, SWMB) may receive another common voltage VCOM6.

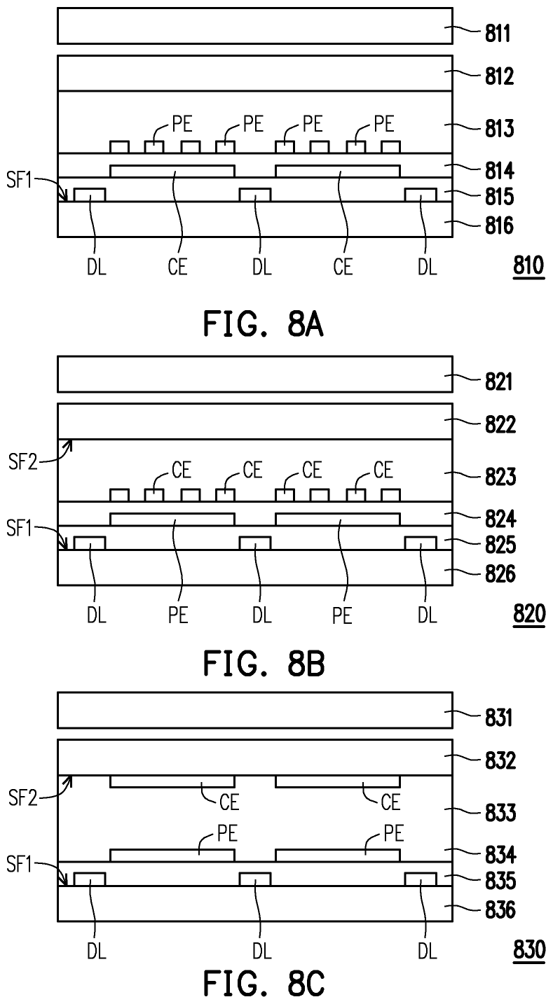

Referring to FIG. 8A to FIG. 8C, FIG. 8A to FIG. 8C are structural diagrams of different implementations of a touch display panel of the touch display apparatus according to an embodiment of the invention. In FIG. 8A, the touch display panel 810 includes a touch substrate 811, a first substrate 816, a second substrate 812, a display medium layer 813, insulation layers 814 and 815, data transmission lines DL, pixel electrodes PE and common electrodes CE of a display pixel. In this implementation, the data transmission lines DL are disposed on a surface SF1 of the first substrate 816. The insulation layer 815 is disposed on the surface SF1 of the first substrate 816, and covers the data transmission lines DL. The common electrodes CE may be disposed on the insulation layer 815, and the insulation layer 814 is disposed on the insulation layer 815 and covers the common electrodes CE.

Moreover, the display medium layer 813 is disposed between the second substrate 812 and the insulation layer 814, and the pixel electrodes PE of the display pixel are disposed on an upper surface of the insulation layer 814 in the display medium layer 813. Moreover, the touch substrate 811 may be disposed on the second substrate 812.

It should be noted that in the embodiment, the first substrate 816 and the second substrate 812 may all be glass substrates.

Moreover, in FIG. 8B, the touch display panel 820 includes a touch substrate 821, a first substrate 826, a second substrate 822, a display medium layer 823, insulation layers 824 and 825, data transmission lines DL, pixel electrodes PE and common electrodes CE of a display pixel. In this implementation, the data transmission lines DL are disposed on the surface SF1 of the first substrate 826. The insulation layer 825 is disposed on the surface SF1 of the first substrate 826, and covers the data transmission lines DL. The pixel electrodes PE of the display pixel may be disposed on the insulation layer 825, and the insulation layer 824 is disposed on the insulation layer 825 and covers the pixel electrodes PE.

Moreover, the display medium layer 823 is disposed between a lower surface SF2 of the second substrate 822 and the insulation layer 824, and the common electrodes CE are disposed on an upper surface of the insulation layer 824 in the display medium layer 823. Moreover, the touch substrate 821 may be disposed on the second substrate 822.

In FIG. 8C, the touch display panel 830 includes a touch substrate 831, a first substrate 835, a second substrate 832, a display medium layer 833, an insulation layer 834, data transmission lines DL, pixel electrodes PE and common electrodes CE of a display pixel. In this implementation, the data transmission lines DL are disposed on the surface SF1 of the first substrate 835. The insulation layer 834 is disposed on the surface SF1 of the first substrate 835, and covers the data transmission lines DL. The display medium layer 833 is disposed between the insulation layer 834 and the surface SF2 of the second substrate 832. The pixel electrodes PE of the display pixel may be disposed on the insulation layer 834, and the common electrodes CE are disposed on the surface SF2 of the second substrate 832.

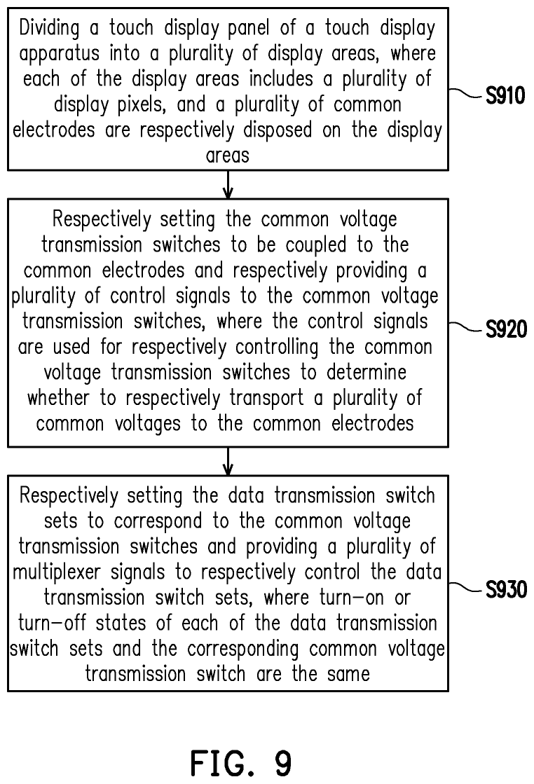

Referring to FIG. 9, FIG. 9 is a flowchart illustrating a controlling method of a touch display apparatus according to an embodiment of the invention. In the embodiment, the touch display apparatus includes the touch display panel 110 shown in the embodiment of FIG. 1. In the controlling method of the embodiment, in step S910, the touch display panel of the touch display apparatus is divided into a plurality of display areas. Each of the display areas includes a plurality of display pixels, and a plurality of common electrodes are respectively disposed on the display areas. In step S920, a plurality of common voltage transmission switches are set to be respectively coupled to the common electrodes, and a plurality of control signals are respectively provided to the common voltage transmission switches. Herein, the control signals are used for respectively controlling the common voltage transmission switches to determine whether to respectively transport a plurality of common voltages to the common electrodes. In step S930, a plurality of data transmission switch sets are set to correspond to the common voltage transmission switches, and a plurality of multiplexer signals are provided to respectively control the data transmission switch sets, where turn-on or turn-off states of each of the data transmission switch sets and the corresponding common voltage transmission switch are the same.

Implementation details of the above steps have been described in the aforementioned embodiments and implementations, so that details thereof are not repeated.

In summary, the display pixels of the invention are divided into a plurality of display areas, and a plurality of common electrodes is configured corresponding to the display areas. A plurality of common voltage transmission switches is used to respectively control receiving states of the common voltages on the common electrodes. When the display pixel does not perform a charging operation (the connection with the data transmission line is cut off), the corresponding common electrode and the common voltage are synchronously cut off. In this way, voltages on both ends of a pixel capacitor of the display pixel may have a similar voltage recovery capability, and in case of noise interference, the variation of display brightness is effectively reduced to improve the display quality.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A touch display apparatus, comprising:
a touch display panel, comprising:
a plurality of display pixels, disposed on the touch display panel and divided into a plurality of display areas;
a plurality of common electrodes, disposed on the touch display panel and respectively corresponding to the display areas;
a plurality of common voltage transmission switches, respectively coupled to the common electrodes, wherein the common voltage transmission switches respectively determine whether to respectively transport a plurality of common voltages to the common electrodes according to a plurality of control signals; and
a plurality of data transmission switch sets, respectively corresponding to the common voltage transmission switches, wherein the data transmission switch sets are respectively controlled by a plurality of multiplexer signals, and turn-on or turn-off states of each of the data transmission switch sets and the corresponding common voltage transmission switch are identical.

2. The touch display apparatus as claimed in claim 1, wherein the common voltage transmission switches comprise at least one first common voltage transmission switch and at least one second common voltage transmission switch, the at least one first common voltage transmission switch receives a first common voltage and is controlled by a first control signal to transmit the first common voltage to at least one first common electrode, and the at least one second common voltage transmission switch receives a second common voltage and is controlled by a second control signal to transmit the second common voltage to at least one second common electrode.

3. The touch display apparatus as claimed in claim 2, wherein turn-on and turn-off states of the at least one first common voltage transmission switch and the at least one second common voltage transmission switch are different.

4. The touch display apparatus as claimed in claim 2, wherein the data transmission switch sets comprise:
at least one first data transmission switch set, coupled to a plurality of first pixels corresponding to the at least one first common electrode and controlled by a first multiplexer signal; and
at least one second data transmission switch set, coupled to a plurality of second pixels corresponding to the at least one second common electrode and controlled by a second multiplexer signal.

5. The touch display apparatus as claimed in claim 4, wherein the first multiplexer signal and the first control signal are identical, and the second multiplexer signal and the second control signal are identical.

6. The touch display apparatus as claimed in claim 2, wherein the common voltage transmission switches further comprise at least one third common voltage transmission switch, and the at least one third common voltage transmission switch receives a third common voltage and is controlled by a third control signal to transmit the third common voltage to at least one third common voltage.

7. The touch display apparatus as claimed in claim 1, further comprising:
a plurality of data transmission lines, coupled to the data transmission switch sets, wherein
each of the data transmission lines extend along a first direction, each of the common electrodes extends along a second direction, and the first direction is parallel with the second direction.

8. The touch display apparatus as claimed in claim 1, wherein a size of each of the common voltage transmission switches is smaller than a size of a data transmission switch of each of the data transmission switch sets.

9. The touch display apparatus as claimed in claim 1, further comprising:
a common voltage generator, coupled to the common voltage transmission switches and configured to provide the common voltages.

10. The touch display apparatus as claimed in claim 1, wherein the touch display panel comprises:
a first substrate;
a plurality of data transmission lines, disposed on a surface of the first substrate;
a display medium layer, disposed between the first substrate and a second substrate;
the second substrate, disposed above the surface of the first substrate, wherein the common electrodes and the display pixels are disposed between the first substrate and the second substrate; and
a touch substrate, disposed on a first surface of the second substrate.

11. A controlling method, adapted to a touch display apparatus, wherein the touch display apparatus comprises a touch display panel, the touch display panel comprises a plurality of display pixels, a plurality of common electrodes, a plurality of common voltage transmission switches, and a plurality of data transmission switch sets, and the controlling method comprises:
dividing the touch display panel into a plurality of display areas, wherein each of the display areas comprises the display pixels, and the common electrodes are respectively disposed on the display areas;
respectively setting the common voltage transmission switches to be coupled to the common electrodes and respectively providing a plurality of control signals to the common voltage transmission switches, wherein the control signals are used for respectively controlling the common voltage transmission switches to determine whether to respectively transport a plurality of common voltages to the common electrodes; and
respectively setting the data transmission switch sets to correspond to the common voltage transmission switches and providing a plurality of multiplexer signals to respectively control the data transmission switch sets,
wherein turn-on or turn-off states of each of the data transmission switch sets and the corresponding common voltage transmission switch are the same.

12. The controlling method as claimed in claim 11, wherein the step of respectively setting the common voltage transmission switches to be coupled to the common electrodes and respectively providing the control signals to the common voltage transmission switches comprises:
providing at least one first common voltage transmission switch to be coupled to at least one first common electrode and providing at least one second common voltage transmission switch to be coupled to at least one second common electrode; and
setting the at least one first common voltage transmission switch to transmit a first common voltage to the at least one first common electrode according to a first control signal and setting the at least one second common voltage transmission switch to transmit a second common voltage to the at least one second common electrode according to a second control signal,
wherein turn-on and turn-off states of the at least one first common voltage transmission switch and the at least one second common voltage transmission switch are different.

13. The controlling method as claimed in claim 12, wherein the step of respectively setting the data transmission switch sets to correspond to the common voltage transmission switches and providing the multiplexer signals to respectively control the data transmission switch sets comprises:
setting at least one first data transmission switch set to be coupled to a plurality of first pixels corresponding to the at least one first common electrode;
setting at least one second data transmission switch set to be coupled to a plurality of second pixels corresponding to the at least one second common electrode; and
providing a first multiplexer signal and a second multiplexer signal to respectively control the at least one first data transmission switch set and the at least one second data transmission switch set,
wherein the first multiplexer signal and the first control signal are identical, and the second multiplexer signal and the second control signal are identical.
